(19) United States
(12) Patent Application Publication
(10) Pub. No.: US 2007/0288889 A1
(43) Pub. Date: Dec. 13, 2007

(54) Source Code Commenting Via Speech Recording and Recognition

(76) Inventors: Christopher Harrison, Mount Kisco, NY (US); Meng Mao, Oak Ridge, NC (US); Christopher G. Parker, Cleveland, OH (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/422,898

(22) Filed: Jun. 8, 2006

(51) Int. Cl. G06F 9/44

(52) U.S. Cl. 717/110

(57) ABSTRACT

A computer programmer can verbally add comments to source code by making verbal utterances into a microphone. These utterances are detected and recorded with an audio recording program. The recorded utterances are converted to text which also contain references to the audio data. The programmer indicates relevant source code positions by using key phrases in the utterances or by cursor position. The text and links to the audio recording are then inserted into relevant source code positions as comments.

### BACKGROUND

1. Field of the Invention

The embodiments of the invention generally relate to programming, and, more particularly, to a method enabling a computer programmer to verbally add comments to source code at appropriate positions during programming of the code.

2. Description of the Related Art

Conventional systems for adding comments to source code involve the manual addition by typing comments into a source code editing program. A comment is a text note added to source code to provide explanatory information, usually about the function of the code. Comments are usually helpful to someone maintaining or enhancing code when the original programmer or programmers are no longer around to answer questions about the code. Often, however comments may be overlooked or less detailed because the process of adding comments may slow a programmer down or distract him from his job of coding. Additionally, the addition of verbal comments contemporaneous with the process of coding would increase the efficiency of the programmer and the quality of his work.

U.S. Pat. No. 6,951,010 B2, incorporated herein by reference, discloses program specification systems with source code and comment statements.

US Patent Application US20020078071 A1, incorporated herein by reference, discloses comment driven processing with versions of sources code during its life cycle that are recorded in the version management file. Each version has a comment attached to it. This publication also discloses inserting in the comment field of the version management file associated with each software module one or more tags each tag relating to an attribute of the software module

### SUMMARY

In view of the foregoing, an embodiment of the invention provides a method enabling a computer programmer to verbally add comments to source code contemporaneous with the typing of code or subsequent to programming the code.

Comments in source code constitute a major component of effective software documentation. However, programmers often choose to comment their code after implementation because it is too time consuming and distracting to comment their code as they program which interrupts the flow of the users thought. The less effort a programmer puts into commenting his code, the more productive he becomes. Any system that enables the programmer to comment his code more easily would make programming easier and less frustrating, and provide for increased coding output. Additionally, others working with the source code would have the benefit of those comments.

This method provides for a technique for commenting source code using speech recording and recognition. Computer programmers speak into a microphone as they program. Their speech is interpreted as comments on the code they are writing. To future reviewers of the source code, the programmer's sound recording and written speech recognition comments are available.

The present method provides ease of comment entry into source code. Comment entry is more efficient with the present method because people speak much faster than they type. Thus, the programmer can provide comments on more code in a shorter amount of time. Additionally, the programmer may add comments contemporaneously with coding. The contemporaneous addition of relevant comments associated with code allows for easier commenting and possibly more frequent commenting. The ease of comment entry with the present method is very useful to the programmer himself and for those maintaining or enhancing the source code.

In another embodiment of the invention, discussed further below, a user may play through the comments linearly, i.e., line by line, or the use may play the comments along the execution path of the programs, in a debug mode, for example.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a flow diagram illustrating a preferred method of an embodiment of the invention; and

FIG. 2 illustrates a schematic diagram of the minimally required hardware to practice the present method.

### DETAILED DESCRIPTION OF PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

The software and interface through which a programmer uses the speech commenting system of the present method, comprises: a conventional microphone, such as Logitech® USB Desktop Microphone made by Logitech Inc. of Fremont, Calif., conventional audio recording and speech recognition software, such as IBM Viavoice™ for Windows made by IBM Corp., Armonk, N.Y., and integration with a conventional source code editor such as Multi-Edit™ made by ME Software, Inc. of Scottsdale, Ariz. or Eclipse made by Eclipse Foundation, Inc. of Ottawa, Ontario Canada.

Contemporaneous with or even after programming a specific line of code, the system monitors the programmer's voice and the programmer decides whether the system should accept his speech as comments based on keyword recognition, special keystrokes application, etc. This aspect of the invention is beneficial since the programmer may need to speak to other people or otherwise not speak while he is writing or attending other tasks. Whenever, the programmer sets the system to accept speech as comment, the system places the transcribed speech as a comment positioned proximally to (for example, above) the line currently being typed by default. In other words, the cursor position, while the programmer is coding, dictates placement of the comment.

The programmer may dictate the placement of a comment by spoken means as well. If the programmer precedes his comment with a special directive, such as “in this block:” or “in this function,” the system will recognize the directive as a command to place the comment in the desired position.

As mentioned, there remains a need for a means to more efficiently and easily add comments to source code while the programmer is engaged in programming or after programming is completed. The embodiments of the invention achieve this by providing a way for computer programmers to verbally add such comments by reciting specific phrases, utterances and verbal comments. The method of the present invention involves a method enabling a computer programmer to verbally add comments to source code by detecting spoken verbal utterances made by the programmer with a microphone. These utterances are recorded and converted to text and links to the audio recording. The programmer indicates a relevant source code position by key phrases detected in said utterances or the manual positioning of the cursor position within the body of the source code. Once the appropriate position is indicated the text and links are inserted appropriately.

The method of the present invention further allows for the verbal insertion of text and said links to be enabled or disabled at the discretion of the user through dedicated keywords, keystrokes, or graphic icon clicking with a pointing device. This allows the programmer the flexibility to determine whether the system should accept his spoken utterances as comments, since he may need to speak to others or attend other tasks while he is writing the code.

Another embodiment of the invention allows for the programmer replay the recording of his utterances. This allows the programmer to have an additional check on the accuracy of his recorded comments. The audio recording of the comments plays back linearly, i.e, line by line. Additionally, the comments may be played back along the execution pate of the program, in a debug mode for example. The output of the comments would be different based on how they are played back by the user. The playback of the audio recording of the comments through the execution path is beneficial to the process of debugging the code.

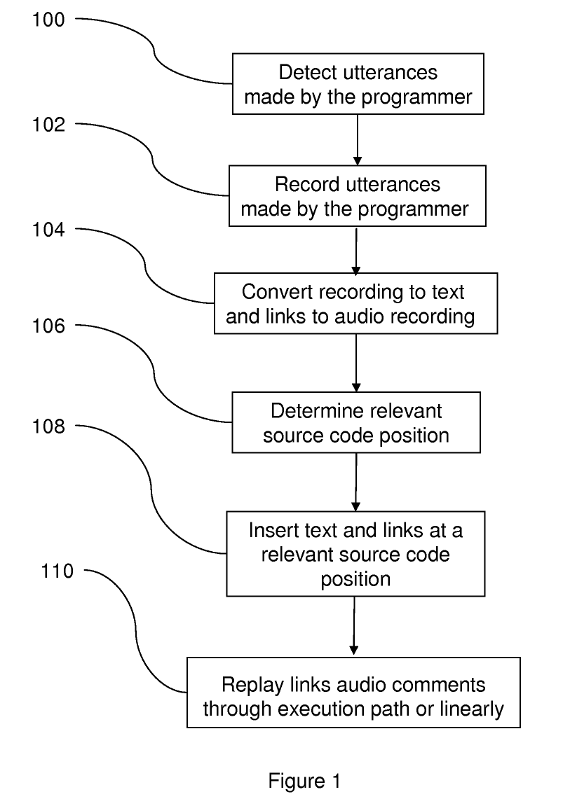

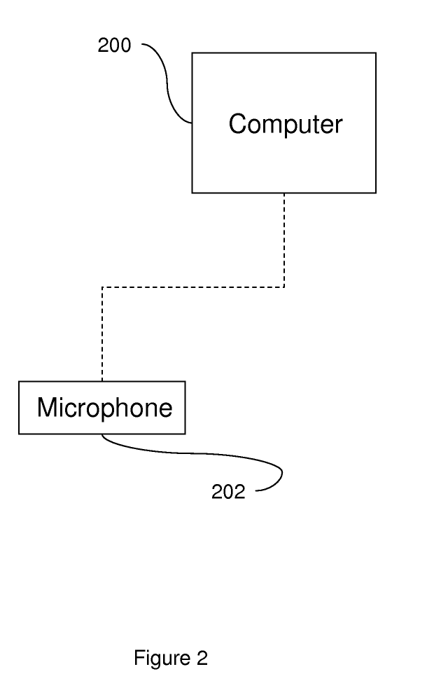

Referring now to the drawings, and more particularly to FIGS. 1 and 2, where reference characters denote corresponding features consistently throughout the figures, there is shown preferred embodiments of the invention.

FIG. 1 illustrates a flow diagram according to an embodiment of the invention. The present method enables the verbal insertion of comments to source code by a computer programmer. The method involves the detecting of utterances (100) made by the programmer with a microphone. These utterances made by the programmer into a microphone are detected and recorded by an audio recording program (102). Those utterances made by the programmer are converted into text and links, i.e., references (links to audio recordings), to the audio recording of the utterance by the audio recording program (104). The programmer indicates a relevant source code position by key phrases uttered by the programmer or the position of a cursor as the programmer types the code. The programmer could also go back to add comments to code that has been already written by spoken key phrases or cursor position (106). The converted text and links are inserted at the relevant source code position (108). The links to audio comments are replayed through the execution path of the program (110).

More particularly describing aspects of the invention, the method plays back comments as the code executes such that it reads like a story. In the linear mode the comments play back ones as the replay mode plays through the comments ones as it goes through each lie of code. However, in the execution replay mode, the comment replay as each line is executed. For example, if a comment is added in line 3 of the code, and line 3 is executed again through the execution path the comment associated with line 3 is again replayed because in this illustration there is a loop which repeatedly calls a function. Such a playback mode as described herein is helpful when debugging or understanding what code does as it executes.

A representative hardware environment for practicing the embodiments of the invention is depicted in FIG. 2. This schematic drawing illustrates a hardware configuration of a computer system in accordance with the embodiments of the invention. The system comprises at least one processor or central processing unit (CPU) (200) and at least one microphone (202).

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A method enabling a computer programmer to verbally add comments to source code comprising:
detecting utterances made by said programmer with a microphone;
recording said utterances detected from said programmer with an audio recording program;
converting said utterances recorded by said audio recording program to text;
creating links to said audio recording;
indicating a relevant source code position determined by cursor; and
inserting said text and links to said voice recording at said relevant source code position.

2. The method of claim 1, further comprising one of enabling and disabling said inserting of said text and said links.

3. The method of claim 1, further comprising replaying said recording of said utterances.

4. A method enabling a computer programmer to verbally add comments to source code comprising:
detecting utterances made by said programmer with a microphone;
recording said utterances detected from said programmer with an audio recording program;
converting said utterances recorded by said audio recording program to text;
creating links to said audio recording;
indicating a relevant source code position determined by key phrases detected in said utterances;
inserting said text and links to said voice recording at said relevant source code position; and
replaying said recording of said utterances.

5. The method of claim 4, further comprising one of enabling and disabling said inserting of said text and said links.

6. The method of claim 4, said replaying further comprising replaying said recording of said utterances through the execution path of said source code.
